(19) United States
(12) Patent Application Publication
(10) Pub. No.: US 2010/0008520 A1
(43) Pub. Date: Jan. 14, 2010

(54) Noise Suppression Estimation Device and Noise Suppression Device

(75) Inventors: Hiroshi SARUWATARI, Ikoma-shi (JP); Yoshihisa Uemura, Nara-shi (JP); Kazunobu Kondo, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignees: Yamaha Corporation, Hamamatsu-shi (JP); Nara Institute of Science and Technology National University Corporation, Ikoma-shi (JP)

(21) Appl. No.: 12/499,734

(22) Filed: Jul. 8, 2009

(30) Foreign Application Priority Data
Jul. 9, 2008 (JP) 2008-179443
Jul. 9, 2008 (JP) 2008-179444

(51) Int. Cl. H04B 15/00

(52) U.S. Cl. 381/94.2

(57) ABSTRACT

A noise suppression estimation device calculates a noise index value which varies according to kurtosis of a frequence distribution of magnitude of a sound signal before or after suppression of the noise component, the noise index value indicating a degree of occurrence of musical noise after suppression of the noise component in a frequency domain. For example, the noise suppression estimation device calculates first kurtosis of a frequence distribution of magnitude of the sound signal before suppression of the noise component, calculates second kurtosis of a frequence distribution of magnitude of the sound signal after suppression of the noise component, and calculates the noise index value from the first kurtosis and the second kurtosis.

### BACKGROUND OF THE INVENTION

1. Technical Field of the Invention

The invention relates to a technology for estimating a process of suppressing a noise component of a sound signal.

2. Description of the Related Art

Technologies for suppressing a noise component of a sound signal in which a signal component (i.e., the component of a target sound) and the noise component are superimposed have been suggested in the past. For example, Non-Patent Reference 1 and Non-Patent Reference 2 describe a Spectral Subtraction (SS) technology which suppresses a noise component in a sound signal in the frequency domain.

However, in a method in which a noise component is suppressed in a sound signal in the frequency domain as in Non-Patent Reference 1 and Non-Patent Reference 2, there is a problem in that the noise component remains in a distributed manner in the time axis and the frequency axis after suppression of the noise component, and it is perceived as harsh musical noise such as birdie noise or chirping by the listener. Thus, Non-Patent Reference 3 suggests a technology in which musical noise due to suppression of the noise component is removed after the musical noise is generated.

[Non-Patent Reference 1] Steven F. Boll. “Suppression of Acoustic Noise in Speech Using Spectral Subtraction”, IEEE TRANSACTIONS ON ACOUSTICS, SPEECH, AND SIGNAL PROCESSING, Vol. ASSP-27, No. 2, April 1979

[Non-Patent Reference 2] Yariv Ephraim, David Malah, “Speech Enhancement Using a Minimum Mean-Square Error Short-Time Spectral Amplitude Estimator”, IEEE TRANSACTIONS ON ACOUSTICS, SPEECH, AND SIGNAL PROCESSING, Vol. ASSP-32, No. 6, December 1984

[Non-Patent Reference 3] Tomomi Abe, Mitsuharu Matsumoto, Shuji Hashimoto, “Removal of Musical Noise through M conversion of Time-Frequency M-Transform”, Acoustical Society of Japan, 3-6-9, p. 727-p. 730, March 2008

If it is possible to quantitatively estimate the degree of occurrence of musical noise after noise suppression, it will also be possible, for example, to realize a configuration that variably controls the degree of suppression of the noise component so that musical noise can be removed appropriately. However, neither Non-Patent Reference 1 nor 2 describes a method for quantitatively estimating the degree of occurrence of musical noise. Non-Patent Reference 3 merely describes removal of musical noise after musical noise is generated and does not provide any description of quantitative estimation of musical noise, similar to Non-Patent References 1 and 2.

### SUMMARY OF THE INVENTION

In consideration of these circumstances, it is an object of the invention to provide a quantitative index of the degree of occurrence of musical noise.

In order to achieve the above object, a noise suppression estimation device associated with the invention comprises: an acquiring part that acquires a sound signal containing a signal component and a noise component; and an index calculation part that calculates a noise index value which varies according to kurtosis of a frequence distribution of magnitude of the sound signal before or after (i.e., before, after, or before and after) suppression of the noise component, the noise index value indicating a degree of occurrence of musical noise after suppression of the noise component in a frequency domain.

In a preferable embodiment of the invention, the index calculator part comprises: a correlation specification part that specifies a relation (function) between a suppression coefficient (for example, a suppression coefficient A) representing a degree of suppression of the noise component and a kurtosis index value (for example, a kurtosis index value Rₘ) according to the kurtosis; and an index determination part that determines the noise index value in terms of the suppression coefficient at which the kurtosis index value approaches or reaches a predetermined value in the relation specified by the correlation specification part.

In this embodiment, the degree of occurrence of musical noise in the sound signal after suppression of the noise component is represented based on the degree of noise suppression required to control the occurrence of musical noise at a desired degree. In addition, the predetermined value, which is a target value of the kurtosis index value, may be either fixed or variable.

In a preferable embodiment of the invention, the index calculator part comprises: a first kurtosis calculation part that calculates first kurtosis of a frequence distribution of magnitude of the sound signal before suppression of the noise component; a second kurtosis calculation part that calculates second kurtosis of a frequence distribution of magnitude of the sound signal after suppression of the noise component; and a calculation part that calculates the noise index value from the first kurtosis and the second kurtosis.

This embodiment provides a noise index value correctly representing the degree of occurrence of musical noise, for example compared to the configuration in which the noise index value is calculated from only one of the first and second kurtosis, since the noise index value is calculated according to both the first and second kurtosis (and the degree of suppression by the noise suppression part is also controlled).

In each of the above embodiments, it is preferable to employ a configuration in which the index calculation part calculates the noise index value such that the degree of occurrence of musical noise represented by the noise index value increases as the first kurtosis of the sound signal before suppression of the noise component decreases (i.e., a configuration in which use of the second kurtosis is not essential), or to employ a configuration in which the index calculation part calculates the noise index value such that the degree of occurrence of musical noise represented by the noise index value decreases as the second kurtosis of the sound signal after suppression of the noise component decreases (i.e., a configuration in which use of the first kurtosis is not essential). The second kurtosis is not only calculated from a sound signal after actual processing of the noise suppression part but is also calculated (or estimated) from a sound signal before suppression by simulating the operation of the noise suppression part (for example, by performing the calculation of Equation (16)).

Taking into consideration the tendency that the degree of change of kurtosis through suppression of the noise component is most significantly reflected in the degree of occurrence of musical noise, it is preferable to employ a configuration in which the index calculation part calculates the noise index value according to first kurtosis of the sound signal before suppression of the noise component and second kurtosis of the sound signal after suppression of the noise component such that the degree of occurrence of musical noise reproduced by the noise index value increases as a ratio of the second kurtosis to the first kurtosis increases.

Particularly, taking into consideration the tendency that the logarithm of the ratio of the second kurtosis to the first kurtosis exhibits a high correlation with the degree of occurrence of musical noise, it is preferable to employ a configuration in which the index calculation part calculates the noise index value according to the logarithm of the ratio of the second kurtosis to the first kurtosis such that the degree of occurrence of musical noise represented by the noise index value increases as the logarithm increases.

The noise index value calculated by the index calculation part is used when a noise suppression device suppresses the noise component. The noise suppression device according to the invention comprises: the noise suppression estimation device (specifically, the index calculation part) associated with each of the above embodiments; a noise suppression part that suppresses the noise component of the sound signal in the frequency domain; and a suppression control part that variably controls the degree of suppression of the noise component by the noise suppression part according to the noise index value.

In this configuration, it is possible to suppress the noise component while controlling (typically, restraining) the occurrence of musical noise effectively, compared to the conventional technology in which the degree of suppression of the noise component by the noise suppression part is fixed, since the degree of suppression of the noise component by the noise suppression part is variably controlled according to the noise index value. For example, it is possible to suppress the noise component while effectively controlling the occurrence of musical noise in a configuration where the suppression control part controls the degree of suppression of the noise component by the noise suppression part according to the noise index value such that the degree of suppression of the noise component increases as the degree of occurrence of musical noise reproduced by the noise index value decreases.

The noise suppression estimation device and the noise suppression device according to the above embodiments may not only be implemented by hardware (electronic circuitry) such as a Digital Signal Processor (DSP) dedicated to noise suppression but may also be implemented through cooperation of a general arithmetic processing unit such as a Central Processing Unit (CPU) with a program. A program associated with the invention causes a computer to perform an acquiring process of acquiring a sound signal containing a signal component and a noise component; and an index calculation process of calculating a noise index value which varies according to kurtosis of a frequence distribution of magnitude of the sound signal before or after suppression of the noise component, the noise index value indicating a degree of occurrence of musical noise after suppression of the noise component in a frequency domain.

This program achieves the same operations and advantages as those of the noise suppression estimation device and the noise suppression device associated with each embodiment of the invention. The program of the invention may be provided to a user through a computer readable recording medium storing the program and then installed on a computer and may also be provided from a server device to a user through distribution over a communication network and then installed on a computer.

### BRIEF DESCRIPTION OF THE DRAWINGS

FIG. 1 is a block diagram of a noise suppression device associated with a first embodiment of the invention.

FIG. 2 is a conceptual diagram illustrating division of a sound signal.

FIG. 3 is a conceptual diagram illustrating how a frequence distribution of magnitude of a sound signal changes through suppression of a noise component of the sound signal.

FIG. 4 is a block diagram of an index calculator.

FIG. 5 is a conceptual diagram illustrating the case where the kurtosis ratio is great (i.e., where the noise index value is great).

FIG. 6 is a conceptual diagram illustrating the case where the kurtosis ratio is small (i.e., where the noise index value is small).

FIG. 7 is a block diagram of an index calculator in a second embodiment of the invention.

### DETAILED DESCRIPTION OF THE INVENTION

### A: First Embodiment

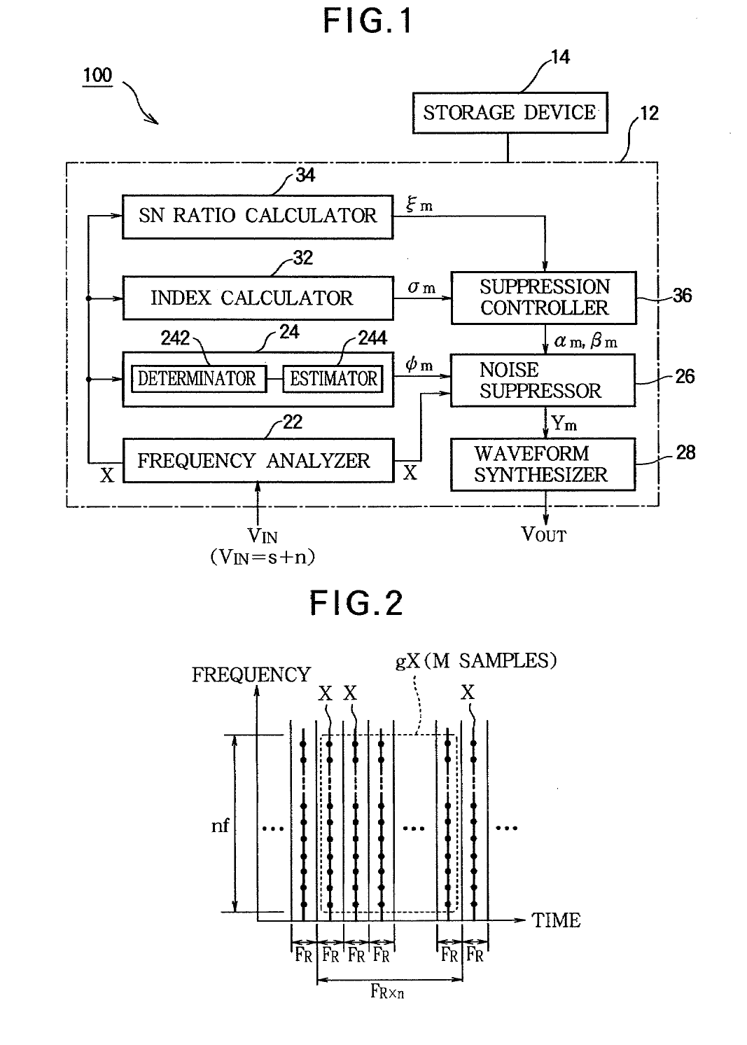

FIG. 1 is a block diagram of a noise suppression device associated with a first embodiment of the invention. A sound signal V_{IN} of the time domain representing a waveform of a sound is provided to the noise suppression device 100. A source (not shown) which provides the sound signal V_{IN} is, for example, a sound receiving device that generates a sound signal V_{IN} according to an ambient sound or a playback device that obtains a sound signal V_{IN} from a recording medium and outputs the sound signal V_{IN}. A signal component s and a noise component n are present together in the sound signal V_{IN} (i.e., V_{IN}=s+n). The noise suppression device 100 generates and outputs a sound signal V_{OUT} (ideally, V_{OUT}=s) by suppressing the noise component n of the sound signal V_{IN}. For example, the sound signal V_{OUT} is provided to a sound emission device (not shown) such as a speaker device or headphones and is then reproduced as a sound wave.

The noise suppression device 100 is implemented as a computer system including a calculation processing device 12 and a storage device 14. The storage device 14 is a machine readable recording medium which stores a program for generating the sound signal V_{OUT} from the sound signal V_{IN} and stores a variety of data. Any known storage medium such as a semiconductor storage device or a magnetic storage device may be employed as the storage device 14.

By executing the program stored in the storage device 14, the calculation processing device 12 may be composed of a computer which functions as a plurality of elements or modules such as a frequency analyzer 22, a noise estimator 24, a noise suppressor 26, a waveform synthesizer 28, an index calculator 32, an SN ratio calculator 34, and a suppression controller 36. The invention also employs a configuration in which an electronic circuit (specifically, a DSP) dedicated to processing of the sound signal V_{IN} implements each element of the calculation processing device 12 or a configuration in which each element of the calculation processing device 12 is mounted on a plurality of integrated circuits in a distributed manner.

The frequency analyzer 22 in FIG. 1 is an acquiring part that acquires the sound signal from the signal source and performs Fourier transform on each of a plurality of frames FR, into which the sound signal V_{IN} is divided in the time axis as shown in FIG. 2, to calculate a frequency spectrum Xₘ(e^{jω}) of the frame FR which is simply denoted by “X” in FIGS. 1 and 2. A frequency spectrum Xₘ(e^{jω}) of an mth frame FR corresponds to the sum of a frequency spectrum Sₘ(e^{jω}) of the signal component s and a frequency spectrum Nₘ(e^{jω}) of the noise component n (see Equation (1)).

Xₘ(e^{jω})=Sₘ(e^{jω})+Nₘ(e^{jω}) (1)

The noise estimator 24 in FIG. 1 estimates a frequency spectrum ψₘ(e^{jω}) of the noise component n superimposed on the sound signal V_{IN} for each of the plurality of frames FR of the sound signal V_{IN}. In the following, the frequency spectrum ψₘ(e^{jω}) is referred to as an “estimated noise spectrum”. As shown in FIG. 1, the noise estimator 24 includes a determinator 242 and an estimator 244. The determinator 242 determines whether a signal component s is present or absent in each frame FR according to the frequency spectrum Xₘ(e^{jω}). The determinator 242 may use any known technology to determine whether the signal component s is present or absent.

The estimator 244 calculates the estimated noise spectrum ψₘ(e^{jω}) using the determination of the determinator 242. More specifically, the estimator 244 calculates the estimated noise spectrum ψₘ(e^{jω}) by averaging the frequency spectrum Xₘ(e^{jω}) for each frame FR within an interval in which the determinator 242 has determined that little or no signal component s is included. In the following, this interval is referred to as a “noise interval”. In the noise interval, the estimated noise spectrum ψₘ(e^{jω}) is calculated from the frequency spectrum Nₘ(e^{jω}) using the following Equation (2) since the frequency spectrum Xₘ(e^{jω}) is approximately identical to the frequency spectrum Nₘ(e^{jω}) in the noise interval. An operator E in Equation (2) denotes calculation of the expected value (or average).

ψₘ(e^{jω})=E{|Nₘ(e^{jω})|²} (2)

In addition, the estimator 244 sets the same estimated noise spectrum ψₘ(e^{jω}) as an immediately previous estimated noise spectrum ψₘ₋₁(e^{jω}) for each frame FR within an interval in which the determinator 242 has determined that a signal component s is included (i.e., ψₘ(e^{jω})=ψₘ₋₁(e^{jω})). In this manner, the estimated noise spectrum ψₘ(e^{jω}) is sequentially updated for each frame FR. The estimator 244 may use any known technology to estimate the estimated noise spectrum ψₘ(e^{jω}).

The noise suppressor 26 is a noise suppression part which suppresses the noise component n (i.e., the frequency spectrum Nₘ(e^{jω})) of the sound signal V_{IN} in the frequency domain. More specifically, the noise suppressor 26 performs subtraction (i.e., spectral subtraction) of the estimated noise spectrum ψₘ(e^{jω}) from the frequency spectrum Xₘ(e^{jω}) sequentially calculated by the frequency analyzer 22 to calculate a frequency spectrum Yₘ(e^{jω}). The frequency spectrum Yₘ(e^{jω}) is simply denoted by “Y” in FIG. 1.

The noise suppressor 26 calculates the frequency spectrum Yₘ(e^{jω}) by adding the phase component e^{jθx(ejω)} of the frequency spectrum Xₘ(e^{jω}) to the square root of a power spectrum Pm calculated according to the estimated noise spectrum ψₘ(e^{jω}) as shown in Equation (3).

Yₘ(e^{jω})=(Pₘ)^{1/2}·e^{jθx(ejω)} (3)

The power spectrum Pm of Equation (3) is calculated using the following Equations (4a) and (4b).

$${P}_{m} = \{ \begin{matrix}{\vert {X}_{m} ( {e}^{j ω} ) \vert}^{2} - {α}_{m} {ψ}_{m} ( {e}^{j ω} ) … ( 4 a ) & {\vert {X}_{m} ( {e}^{j ω} ) \vert}^{2} 〉 {α}_{m} {ψ}_{m} ( {e}^{j ω} ) \\ {β}_{m} {ψ}_{m} ( {e}^{j ω} ) … ( 4 b ) & otherwise\end{matrix} \}$$

That is, a component of the power spectrum Pm in a frequency band, in which the square |Xₘ(e^{jω})|² of the magnitude of the frequency spectrum Xₘ(e^{jω}) is greater than the product (αₘ·ψₘ(e^{jω})) of the estimated noise spectrum ψₘ(e^{jω}) and a coefficient αₘ, is calculated by subtracting the product (αₘ·ψₘ(e^{jω})) from the square |Xₘ(e^{jω})|² of the magnitude of the frequency spectrum Xₘ(e^{jω}) as shown in Equation (4a). On the other hand, a component of the power spectrum Pm in a frequency band, in which the square |Xₘ(e^{jω})|² of the magnitude of the frequency spectrum Xₘ(e^{jω}) is less than or equal to the product (αₘ·ψₘ(e^{jω})) of the estimated noise spectrum ψₘ(e^{jω}) and the coefficient αₘ, is set to the product (βₘ·ψₘ(e^{jω})) of the estimated noise spectrum ψₘ(e^{jω}) and a (flooring) coefficient βₘ as shown in Equation (4b). Details of the coefficients αₘ and βₘ will be described later.

The waveform synthesizer 28 in FIG. 1 synthesizes a sound signal V_{OUT} of the time domain from the frequency spectrum Yₘ(e^{jω}) that the noise suppressor 26 has calculated for each frame FR. More specifically, the waveform synthesizer 28 calculates the sound signal V_{OUT} by adding signals of the time domain, which are calculated by performing inverse Fourier transform on the frequency spectrum Yₘ(e^{jω}) for the plurality of frames FR, through overlapping on the time axis.

Musical noise may be dotted in a distributed manner on the time axis or the frequency axis in the sound signal V_{OUT} in which the noise component n is suppressed by subtracting the estimated noise spectrum ψₘ(e^{jω}) (αₘ·ψₘ(e^{jω})) from the frequency spectrum Xₘ(e^{jω}) as described above. For each frame FR, the index calculator 32 in FIG. 1 constitutes a noise index calculation part which calculates a noise index value σₘ which is a quantitative index of the degree of occurrence of musical noise in the sound signal V_{OUT}. Details of the noise index value σₘ will be described later.

The SN ratio calculator 34 calculates an SN ratio ξₘ of the sound signal V_{IN} for each frame FR. More specifically, the SN ratio calculator 34 calculates, as the SN ratio ξₘ of the mth frame FR, the ratio of the square of the magnitude |Yₘ(e^{jω})|² of the frequency spectrum Yₘ(e^{jω}) of the immediately previous (i.e., m−1th) frame FR to the magnitude |ψₘ(e^{jω})| of the estimated noise spectrum ψₘ(e^{jω}) of the mth frame FR (i.e., ξₘ=|Yₘ(e^{jω})|²/|ψₘ(e^{jω})|). Here, the SN ratio calculator 34 may use any method to calculate the SN ratio ξₘ. In addition, the update period of the SN ratio ξₘ is not limited to the frame FR.

The suppression controller 36 is a suppression control part which restrains the occurrence of musical noise in the sound signal V_{OUT} that has been processed by the noise suppressor 26 by variably (or adaptively) controlling the degree of suppression of the noise suppressor 26. The noise suppressor 26 is a noise suppression part which suppresses the noise component n (i.e., the estimated noise spectrum ψₘ(e^{jω})) in the sound signal V_{IN} (i.e., the frequency spectrum Xₘ(e^{jω})), according to the noise index value σₘ calculated by the index calculator 32 and the SN ratio ξₘ calculated by the SN ratio calculator 34.

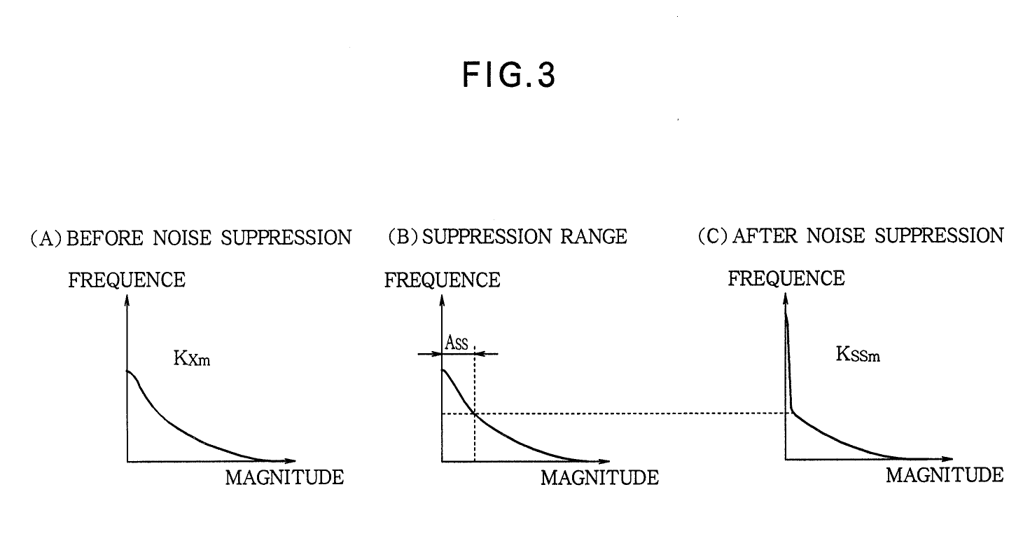

The following is a description of calculation of the noise index value σₘ. FIG. 3(A) illustrates a frequence distribution of the magnitude of the sound signal V_{IN} (in the noise interval in which the determinator 242 determines that the signal component s is small). That is, FIG. 3(A) illustrates a probability density function whose probability variable is the magnitude of the sound signal. As shown in FIG. 3(A), the magnitude of the sound signal V_{IN} is distributed nonlinearly such that the frequence decreases as the magnitude increases from zero. The magnitude is representing strength, amplitude or power of the sound signal.

A range A_{SS} shown in FIG. 3(B) corresponds to the magnitude of the component (αₘ·ψₘ(e^{jω})) that the noise suppressor 26 subtracts from the sound signal V_{IN} (frequency spectrum Xₘ(e^{jω})). The frequence of the magnitude approaching zero in the frequence distribution (shown in FIG. 3(C)) of the magnitude of the sound signal V_{OUT} in which the noise component n has been suppressed is great, compared to that of the frequence distribution (shown in FIG. 3(A)) before suppression of the noise component n. That is, the frequence distribution in the range of magnitude near zero is changed into a shape having a sharp slope after suppression of the noise suppressor 26. When kurtosis is introduced as a measure of the shape of the frequence distribution, the change into the sharp slope shape indicates that, when the noise suppressor 26 has suppressed the noise component n in the sound signal V_{IN}, the kurtosis K_{SSm} of the mth frame FR of the sound signal V_{OUT} (shown in FIG. 3(C)) is increased from the kurtosis K_{Xm} (shown in FIG. 3(A)) of the mth frame FR of the sound signal V_{IN} before suppression (i.e., K_{SSm}>K_{Xm}). The kurtosis κ is a high-order statistic calculated from an nth moment μn using the following Equation (5).

$$κ = \frac{{μ}_{4}}{{μ}_{2}^{2}} - 3 \qquad ( 5 )$$

Musical noise tends to approach zero in magnitude with high frequence. Accordingly, it is possible to estimate that the degree of musical noise generated due to the suppression of the noise component n increases as the frequence of reduction of the magnitude to zero in the frequence distribution increases through suppression of the noise component n. That is, the degree of musical noise generated due to the suppression of the noise component n increases as the degree of the change of the kurtosis κ(K_{Xm}→K_{SSm}) through suppression of the noise component n increases. For example, when it is assumed that there is a plurality of cases with the same kurtosis K_{Xm} of the sound signal V_{IN}, the degree of musical noise after suppression of the noise component n can be estimated to increase as the kurtosis K_{SSm} increases. In addition, when it is assumed that there is a plurality of cases with the same kurtosis K_{SSm} after suppression of the noise component n, the degree of musical noise after suppression of the noise component n can be estimated to increase as the kurtosis K_{Xm} of the sound signal V_{IN} before suppression of the noise component n decreases.

Based on this tendency, the index calculator 32 in FIG. 1 calculates the noise index value σₘ, which is an index of the degree of musical noise in the mth frame FR, according to the kurtosis K_{SSm} after suppression of the noise component n and the kurtosis K_{Xm} of the sound signal V_{IN} before suppression of the noise component n. Here, the index calculator 32 uses a set g_{X} of M magnitudes xᵢ (x₁ to x_{M}) extracted from the sound signal V_{IN} to calculate the noise index value σₘ. As shown in FIG. 2, nf magnitudes xᵢ of a frequency spectrum X of each of the nt frames FR, the last of which is the mth frame FR, are sequentially specified to create the sample set g_{X} including M samples of magnitudes xᵢ(M=nt·nf). An example of the derivation of an equation for use in calculating the noise index value σₘ is described below.

First, a description is given of calculation of the kurtosis K_{Xm} before suppression of the noise component n. The frequence distribution of the magnitudes (i.e., the M magnitudes x₁ to x_{M} of the set g_{X}) of the sound signal V_{IN} is approximated by a Function Ga(x;k,θ) of the following Equation (6).

$$Ga ( x ; k , θ ) = C \cdot {x}^{k - 1} \cdot exp ( - \frac{x}{θ} ) \\ γ = log ( \frac{1}{M} {\sum }_{i = 1}^{M} {x}_{i} ) - \frac{1}{M} {\sum }_{i = 1}^{M} log {x}_{i} \\ k = \frac{3 - γ + \sqrt{{( γ - 3 )}^{2} + 24 γ}}{12 γ} \\ θ = \frac{1}{Mk} {\sum }_{i = 1}^{M} {x}_{i} \qquad ( 6 )$$

A coefficient C in Equation (6) is defined as follows using a Gaussian function Γ(k).

$$C = \frac{1}{{θ}^{k} Γ ( k )}$$

$$\begin{matrix}Γ ( k ) = {\int }_{0}^{∞} {x}^{( k - 1 )} \cdot exp ( - x ) d x \\ = ( k - 1 ) Γ ( k - 1 ) \\ = ( k - 1 ) !\end{matrix}$$

The following Equation (7) is derived by substituting the function Ga(x;k,θ) of Equation (6) into a function P(x) in the definition equation of a 2nd moment μ2.

$$\begin{matrix}\begin{matrix}{μ}_{2} = \int {x}^{2} \cdot P ( x ) d x \\ = {\int }_{0}^{∞} {x}^{2} [ C \cdot {x}^{( k - 1 )} \cdot exp ( - \frac{x}{θ} ) ] d x \\ = C \cdot {θ}^{( k + 2 )} \int {X}^{( k + 2 ) - 1} \cdot exp ( - X ) d X \\ ( X = \frac{x}{θ} ) \\ = C \cdot {θ}^{( k + 2 )} \cdot Γ ( k + 2 )\end{matrix} & ( 7 )\end{matrix}$$

Similar to the derivation of the 2nd moment μ2, the following Equation (8) is derived by substituting the function Ga(x;k,θ) of Equation (6) into a function P(x) in the definition equation of a 4th moment μ4.

$$\begin{matrix}\begin{matrix}{μ}_{4} = {\int }_{0}^{∞} {x}^{4} \cdot P ( x ) d x \\ = {\int }_{0}^{∞} {x}^{4} [ C \cdot {x}^{( k - 1 )} \cdot exp ( - \frac{x}{θ} ) ] d x \\ = C \cdot {θ}^{( k + 4 )} \cdot Γ ( k + 4 )\end{matrix} & ( 8 )\end{matrix}$$

By substituting the 2nd moment μ2 of Equation (7) and the 4th moment μ4 of Equation (8), the kurtosis K_{Xm} of the sound signal V_{IN} before suppression of the noise component n is defined as follows.

$$\begin{matrix}\begin{matrix}{K}_{Xm} = \frac{{μ}_{4}}{{μ}_{2}^{2}} - 3 \\ = \frac{C \cdot {θ}^{( k + 4 )} Γ ( k + 4 )}{{[ C \cdot {θ}^{( k + 2 )} Γ ( k + 2 ) ]}^{2}} - 3 \\ = \frac{\frac{1}{{θ}^{k} Γ ( k )} \cdot {θ}^{( k + 4 )} \cdot ( k + 3 ) ( k + 2 ) ( k + 1 ) k Γ ( k )}{[ \frac{1}{{θ}^{k} Γ ( k )} \cdot {θ}^{( k + 2 )} \cdot ( k + 1 ) k Γ ( k ) ]} - 3 \\ = \frac{( k + 3 ) ( k + 2 )}{( k + 1 ) k} - 3\end{matrix} & ( 9 )\end{matrix}$$

As can be understood from the definition equations of the variable k and the variable γ given in Equation (6), the magnitudes x₁ to x_{M} of the set g_{X} are used to calculate the variable k (or the variable γ used to define the variable k) in Equation (9).

Next, a description is given of calculation of the kurtosis K_{SSm} after suppression of the noise component n. The following Equation (10) is derived by normalizing the average k·θ of the Gaussian function Γ(k).

$$θ = \frac{1}{k} \qquad ( 10 )$$

Now, when it is assumed that the noise suppressor 26 subtracts A times the estimated noise spectrum ψₘ(e^{jω}) (i.e., A·ψₘ(e^{jω})) from the frequency spectrum Xₘ(e^{jω}) (i.e., that the coefficient αₘ of Equation (4a) is set to the coefficient A), the function Gb(x;k,θ) which approximates the frequency domain of the magnitude of the sound signal V_{OUT} after suppression of the noise component n (the estimated noise spectrum ψₘ(e^{jω})) is estimated as in the following Equation (11) obtained by replacing the magnitude x of the definition Equation (6) of the function Ga(x;k,θ) with a magnitude (x+A).

$$Gb ( x ; k , θ ) = C \cdot {( x + A )}^{k - 1} \cdot exp ( - \frac{( x + A )}{θ} ) \qquad ( 11 )$$

Similar to Equation (8), the following Equation (12) is derived by substituting the function Gb(x;k,θ) of Equation (11) into the function P(x) in the definition equation of the 4th moment μ4.

$$\begin{matrix}\begin{matrix}{μ}_{4} = {\int }_{0}^{∞} {x}^{4} \cdot P ( x ) d x \\ = {\int }_{0}^{∞} {x}^{4} [ C \cdot {( x + A )}^{( k - 1 )} \cdot exp ( - \frac{( x + A )}{θ} ) ] d x\end{matrix} & ( 12 )\end{matrix}$$

(x+A)^{k-1} of Equation (12) is expanded into a Taylor series as in the following Equation (13).

$${( x + A )}^{k - 1} = {x}^{k - 1} + A ( k - 1 ) {x}^{k - 2} + {A}^{2} \frac{( k - 1 ) ( k - 2 )}{2} {x}^{k - 3} + … \qquad ( 13 )$$

The following Equation (14) which approximates the 4th moment μ4 is derived by substituting Equation (13) into Equation (12) ignoring the high-order terms of Equation (13) for the sake of convenience.

$${μ}_{4} \approx C \cdot exp ( - \frac{A}{θ} ) \{ \begin{matrix}Γ ( k + 4 ) + A ( k - 1 ) Γ ( k + 3 ) + \\ {A}^{2} \frac{( k - 1 ) ( k - 2 )}{2} Γ ( k + 2 )\end{matrix} \} \qquad ( 14 )$$

Similarly, the following Equation (15) which approximates the 2nd moment μ2 is derived by substituting the function Gb(x;k,θ) of Equation (11) into the function P(x) in the definition equation (i.e., Equation (7)) of the 2nd moment μ2 and then ignoring the high-order terms of Equation (13).

$$\begin{matrix}\begin{matrix}{μ}_{2} = {\int }_{0}^{∞} {x}^{2} \cdot P ( x ) d x \\ = {\int }_{0}^{∞} {x}^{2} [ C \cdot {( x + A )}^{k - 1} \cdot exp ( - \frac{( x + A )}{θ} ) ] d x \\ \approx C \cdot exp ( - \frac{A}{θ} ) Γ ( k + 2 )\end{matrix} & ( 15 )\end{matrix}$$

Then, the following Equation (16), which represents a definition of the kurtosis K_{SSm} after suppression of the noise component n using a variable k and a coefficient (hereinafter referred to as a “suppression coefficient”) A, is derived by substituting the 4th moment μ4 of Equation (14) and the 2nd moment μ2 of Equation (15) into Equation (5). Here, Equation (10) is used to derive Equation (16).

$$\begin{matrix}\begin{matrix}{K}_{SSm} = \frac{{μ}_{4}}{{μ}_{2}^{2}} - 3 \\ \approx exp ( A \cdot k ) \\ \{ \frac{( k + 3 ) ( k + 2 ) + A ( k + 2 ) ( k + 1 ) + \frac{{A}^{2}}{2} ( k - 1 ) ( k - 2 )}{k ( k + 1 )} \} - 3\end{matrix} & ( 16 )\end{matrix}$$

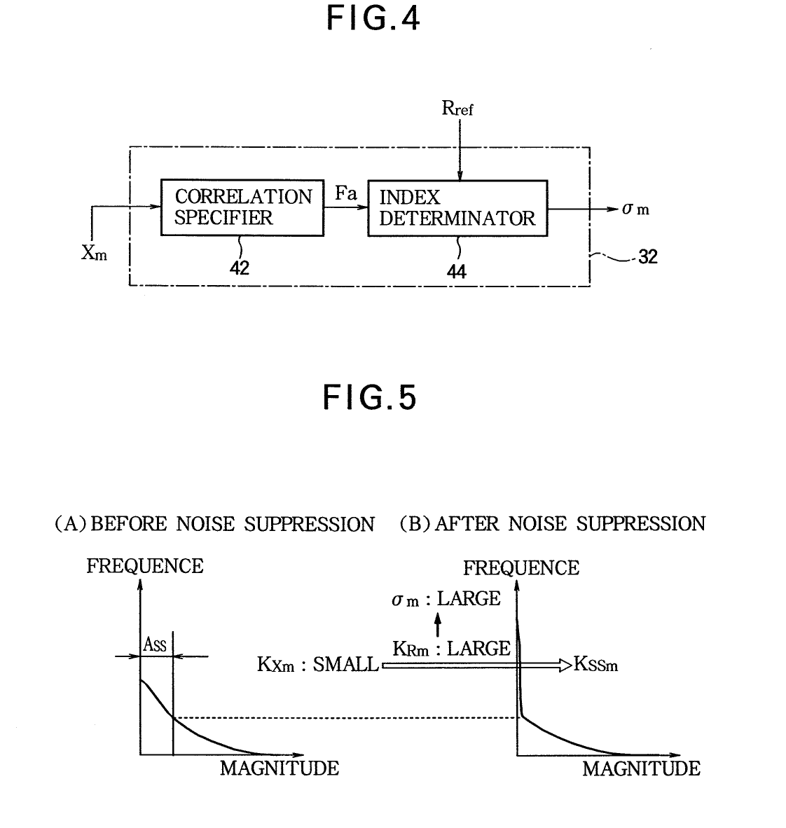

FIG. 4 is a block diagram illustrating a detailed configuration of the index calculator 32. As shown in FIG. 4, the index calculator 32 includes a correlation specifier 42 and an index determinator 44. The correlation specifier 42 is a correlation specifying part which specifies a relation between the suppression coefficient A that represents the degree of suppression of the noise component n (i.e., the estimated noise spectrum ψₘ(e^{jω})) and a kurtosis index value Rₘ according to the kurtosis K_{Xm} and the kurtosis K_{SSm}.

The kurtosis index value Rₘ is defined by a function Fₐ whose variable is the ratio K_{Rm} (=KSSm/K_{Xm}) of the kurtosis K_{SSm} to the kurtosis K_{Xm} as shown in the following Equation (17a). The function Fₐ defines a relation between the kurtosis index value Rₘ and the ratio K_{Rm} so that the kurtosis index value Rₘ monotonically increases with the ratio K_{Rm}.

Rₘ=Fₐ(K_{Rm})=Fₐ(K_{SSm}/K_{Xm}) (17a)

Since the ratio K_{Rm} increases (i.e., the degree of change from the kurtosis K_{Xm} to the kurtosis K_{SSm} increases) as the degree of musical noise after suppression of the noise component n increases as described above with reference to FIG. 3, the degree of musical noise after suppression of the noise component n can be estimated to increase as the kurtosis index value Rₘ increases. In other words, the degree of musical noise after suppression of the noise component n can be estimated to decrease as the kurtosis index value Rₘ decreases (i.e., the degree of change from the kurtosis K_{Xm} to the kurtosis K_{SSm} decreases).

Since the kurtosis K_{Xm} is a function of the variable k as shown in Equation (9) and the kurtosis K_{SSm} is a function of the variable k and the suppression coefficient A as shown in Equation (16), the function Fₐ defines the relation between both the variable k and the suppression coefficient A and the kurtosis index value Rₘ as shown in the following Equation (17b).

Rₘ=Fₐ(K_{SSm}/K_{Xm})=Fₐ(A, k) (17b)

When focusing on the single mth frame FR, the variable k is a fixed value calculated from the M magnitudes x₁ to x_{M} of the set g_{X} (including the nt frames FR, the last of which is the mth frame FR). Accordingly, the kurtosis index value Rₘ is defined by the function Fₐ whose variable is the suppression coefficient A as shown in the following Equation (17c).

Rₘ=Fₐ(A) (17c)

The correlation specifier 42 in FIG. 4 substitutes the variable k calculated from the M magnitudes x₁ to x_{M} of the set g_{X} into Equation (17b) to specify the function Fₐ of Equation (17c) which defines the relation between the suppression coefficient A and the kurtosis index value Rₘ. Since the variable k changes with each frame FR, the correlation specifier 42 specifies the function Fₐ for each frame FR.

The index determinator 44 in FIG. 4 is an index determination part which determines the suppression coefficient A, at which the kurtosis index value Rₘ defined by the function Fₐ specified by the correlation specifier 42 matches a desired value Rref, as the noise index value σₘ. That is, the index determinator 44 calculates the noise index value σₘ for each frame FR by performing the calculation of the following Equation (18). An operator Fₐ⁻¹ in Equation (18) is an inverse mapping of the function Fₐ.

σₘ=Fₐ⁻¹(Rref) (18)

As described above, the noise index value σₘ corresponds to a numerical value of the coefficient αₘ (Equation (4a)) for controlling musical noise, which occurs after the noise suppressor 26 suppresses the noise component n, at a predetermined degree (specifically, for adjusting the kurtosis index value Rₘ at the desired value Rref). In addition, since the numerical value of the noise index value σₘ increases as the kurtosis index value Rₘ increases, the noise index value σₘ also serves as the index of the degree of musical noise occurring in the case where the noise component n of the sound signal V_{IN} is suppressed based on the suppression coefficient A. That is, the sound signal V_{IN} is estimated to have characteristics such that musical noise more easily occurs as the noise index value σₘ increases and musical noise less easily occurs as the noise index value σₘ decreases. As described above, each of the kurtosis index value Rₘ and the noise index value σₘ serves as an index that quantitatively represents the degree of musical noise occurring in the sound signal V_{OUT} when the noise component n has been suppressed based on the suppression coefficient A.

The suppression controller 36 of FIG. 1 variably controls the coefficients αₘ and βₘ that the noise suppressor 26 uses to suppress the noise component n (as shown in Equations (4a) and (4b)) according to both the noise index value σₘ calculated by the index calculator 32 and the SN ratio ξₘ calculated by the SN ratio calculator 34. The following is a description of a detailed operation of the suppression controller 36.

For example, the suppression controller 36 calculates a coefficient αₘ according to the noise index value σₘ and the SN ratio ξₘ by calculating the following Equation (19). A coefficient a_{g1} and a coefficient a_{g2} in Equation (19) are each a positive number that is, for example, empirically or statistically set so as to efficiently reduce the musical noise of the sound signal V_{OUT}.

αₘ=g(σₘ, ξₘ)=−a_{g1}·σₘ²+a_{g2}·ξₘ (19)

As can be understood from Equation (19), the coefficient αₘ decreases as the noise index value σₘ increases. Accordingly, the value (i.e., αₘ·ψₘ(e^{jω})) that the noise suppressor 26 subtracts from the frequency spectrum Xₘ(e^{jω}) decreases as the probability that musical noise occurs through suppression of the noise component n by the noise suppressor 26 increases (i.e., as the noise index value σₘ increases).

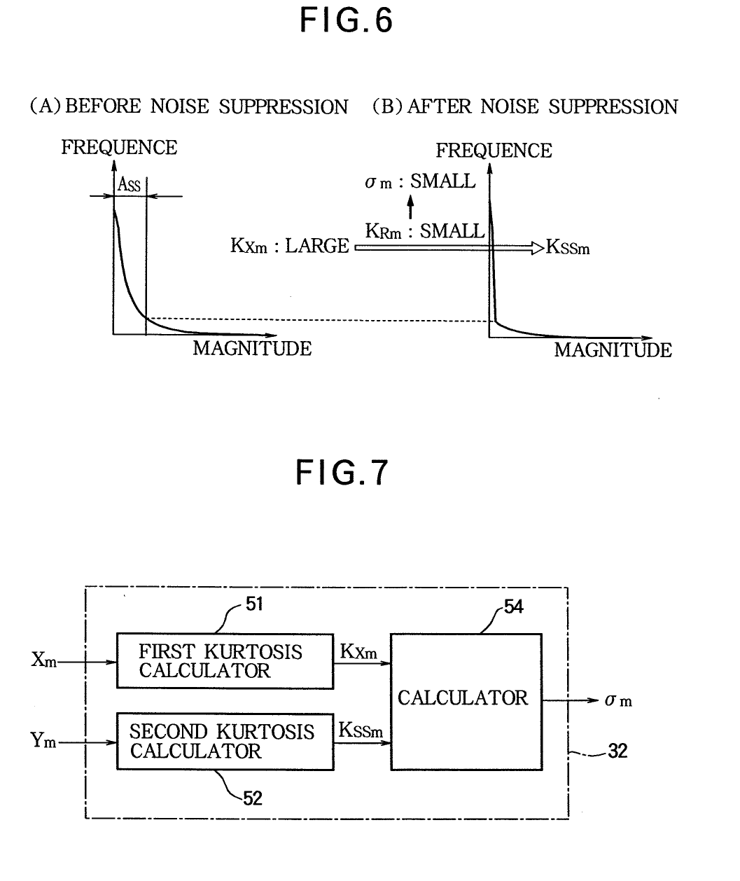

For example, when the kurtosis K_{Xm} of the sound signal V_{IN} is sufficiently smaller than the kurtosis K_{SSm} after suppression as shown in FIGS. 5A and 5B (for example, when the kurtosis K_{Xm} of the sound signal V_{IN} is less Gaussian than the normal distribution, the noise index value σₘ (or the kurtosis index value Rₘ) has a great numerical value and therefore the coefficient αₘ is set to a small numerical value to decrease the value (i.e., αₘ·ψₘ(e^{jω})) for subtraction from the frequency spectrum Xₘ(e^{jω}). On the other hand, when the kurtosis K_{Xm} of the sound signal V_{IN} is great as shown in FIGS. 6A and 6B (for example, when the kurtosis K_{Xm} of the sound signal V_{IN} is more Gaussian than the normal distribution), the noise index value σₘ has a small numerical value and therefore the coefficient αₘ is set to a large numerical value to increase the value (i.e., αₘ·ψₘ(e^{jω}) for subtraction from the frequency spectrum Xₘ(e^{jω})). Since the coefficient αₘ is set variably according to the noise index value σₘ in this manner, the kurtosis index value Rₘ of the sound signal V_{OUT} after actual processing by the noise suppressor 26 approximately matches a desired (or target) value Rref when the effects of the SN ratio ξₘ are ignored for the sake of convenience in Equation (19).

As can be understood from Equation (19), the coefficient αₘ increases as the SN ratio ξₘ calculated by the SN ratio calculator 34 increases. Accordingly, the value (i.e., αₘ·ψₘ(e^{jω})) that the noise suppressor 26 subtracts from the frequency spectrum Xₘ(e^{jω}) increases as the SN ratio ξₘ of the sound signal V_{IN} increases (i.e., as the magnitude of the signal component s is greater than the magnitude of the noise component n).

In addition, for example, the suppression controller 36 calculates a coefficient βₘ according to the noise index value σₘ and the SN ratio ξₘ by calculating Equation (20). Similar to the coefficient a_{g1} and the coefficient a_{g2} in Equation (19), a coefficient aₕ₁ and a coefficient aₕ₂ in Equation (20) are each a positive number that is, for example, empirically or statistically set so as effectively reduce the musical noise of the sound signal V_{OUT}.

βₘ=h(σₘ, ξₘ)=−aₕ₁·σₘ²+aₕ₂·ξₘ (20)

As can be understood from Equation (20), the coefficient βₘ decreases as the noise index value σₘ increases. Accordingly, the magnitude (βₘ·ψₘ(e^{jω})) of the component of a frequency band in which the magnitude |Xₘ(e^{jω})|² of the frequency spectrum Xₘ(e^{jω}) is smaller than the product (αₘ·ψₘ(e^{jω})) of the estimated noise spectrum ψₘ(e^{jω}) and the coefficient αₘ decreases as the degree of occurrence of musical noise through suppression of the noise component n by the noise suppressor 26 increases (i.e., as the noise index value σₘ increases). In addition, the coefficient βₘ increases as the SN ratio ξₘ increases. Accordingly, the magnitude (βₘ·ψₘ(e^{jω})) of the component of the frequency band in which the magnitude |Xₘ(e^{jω})|² of the frequency spectrum Xₘ(e^{jω}) is smaller than the product (αₘ·ψₘ(e^{jω})) of the estimated noise spectrum ψₘ(e^{jω}) and the coefficient αₘ decreases as the SN ratio ξₘ of the sound signal V_{IN} decreases.

In this embodiment, the degree (αₘ·ψₘ(e^{jω})) of suppression of the noise component n by the noise suppressor 26 is controlled variably according to the noise index value σₘ as described above. More specifically, the degree of suppression by the noise suppressor 26 (i.e., the subtracted value) decreases as the noise index value σₘ increases. Accordingly, compared to the technology in which the degree of suppression of the noise component n is fixed, this embodiment is advantageous in that it is possible to efficiently suppress the noise component n of the sound signal V_{IN} while effectively restraining the occurrence of musical noise, regardless of an environment in which the sound signal V_{IN} is recorded (i.e., regardless of characteristics of the sound signal V_{IN}).

In a configuration in which the coefficient αₘ is set to a high fixed value so as to sufficiently restrain the noise component n, it is certainly possible to sufficiently restrain the noise component n. However, for example, when the sound signal V_{IN} has characteristics of FIG. 5(A) (i.e., when musical noise easily occurs), there is a problem in that significant musical noise easily occurs in the sound signal V_{OUT} due to excessive suppression of the noise component n. In this embodiment, when the noise index value σₘ is high as in FIGS. 5A and 5B (i.e., when musical noise easily occurs in the sound signal V_{OUT}), the degree of suppression by the noise suppressor 26 is reduced so that musical noise of the sound signal V_{OUT} is effectively restrained.

On the other hand, in a configuration in which the coefficient αₘ is set to a low fixed value so as to appropriately restrain the noise component n, it is certainly possible to restrain the noise component n in the sound signal V_{OUT}. However, when the sound signal V_{IN} has characteristics of FIG. 6(A), there is a problem in that the degree of suppression of the noise component n is restricted (i.e., the suppression is insufficient), although musical noise hardly occurs in the sound signal V_{OUT} even when the degree of suppression of the noise component n is increased. In this embodiment, when the noise index value σₘ is low as in FIGS. 6A and 6B (i.e., when musical noise hardly occurs in the sound signal V_{OUT}), the degree of suppression by the noise suppressor 26 is increased so that musical noise is efficiently restrained in the sound signal V_{OUT}.

However, in the case where the SN ratio ξₘ of the sound signal V_{IN} is high, there is a tendency that it is difficult for the listener to perceive musical noise in the sound signal V_{OUT} even if the degree of suppression of the noise component n is high. In this embodiment, the degree of suppression by the noise suppressor 26 (i.e., the coefficient αₘ) is controlled according to the SN ratio ξₘ of the sound signal V_{IN}. More specifically, the degree of suppression by the noise suppressor 26 (i.e., the coefficient αₘ) increases as the SN ratio ξₘ increases. Accordingly, this embodiment is advantageous in that the noise component n is effectively restrained in preference to the restraint of musical noise in an environment in which it is difficult to perceive musical noise due to a high SN ratio ξₘ. In other words, in the case where the SN ratio ξₘ of the sound signal V_{IN} is low, the degree of suppression by the noise suppressor 26 (i.e., the coefficient αₘ) is reduced so that musical noise is preferentially restrained in an environment in which it is especially easy to perceive musical noise due to a low SN ratio ξₘ. Of course, the invention also employs a configuration in which the SN ratio calculator 34 is omitted (i.e., a configuration in which only the noise index value σₘ is reflected in the suppression of the noise suppressor 26).

Musical noise of the sound signal V_{OUT} occurs mainly due to the subtraction of the estimated noise spectrum ψₘ(e^{jω}). Therefore, in reducing musical noise, it is important to employ the configuration for variably controlling the coefficient αₘ applied to the subtraction of the estimated noise spectrum ψₘ(e^{jω}). Accordingly, the invention also employs a configuration in which the coefficient βₘ is fixed to a desired value (without depending on the noise index value σₘ). However, in the configuration in which the coefficient βₘ is fixed, the magnitude difference between a band in which Equation (4a) is applied and a band in which Equation (4b) is applied in the frequency spectrum Yₘ(e^{jω}) is excessive so that there is a possibility that a reproduction sound of the sound signal V_{OUT} sounds unnatural. In this embodiment, the magnitude difference between a band in which Equation (4a) is applied and a band in which Equation (4b) is applied is restrained since, similar to the coefficient αₘ, the coefficient βₘ is controlled variably according to the noise index value σₘ and the SN ratio ξₘ. Accordingly, compared to the configuration in which the coefficient βₘ is fixed, this embodiment is advantageous in that it is possible to generate a sound signal V_{OUT} whose reproduction sound is aurally perceived as natural.

### B: Second Embodiment

FIG. 7 is a block diagram of an index calculator 32 associated with a second embodiment of the invention. As shown in FIG. 7, the index calculator 32 of this embodiment includes a first kurtosis calculator 51, a second kurtosis calculator 52, and a calculator 54. Elements of this embodiment shared with the first embodiment are denoted by the same reference numerals as those of the first embodiment and a detailed description of each of the elements is omitted as appropriate.

The first kurtosis calculator 51 in FIG. 7 is a first kurtosis calculation part which calculates a kurtosis K_{Xm} for each frame FR of the sound signal V_{IN}. For example, the first kurtosis calculator 51 calculates the kurtosis K_{Xm} for each frame FR of the sound signal V_{IN} by performing the calculation of Equation (9) on the M magnitudes x₁ to x_{M} of the set g_{X} extracted from the time series of the frequency spectrum Xₘ(e^{jω}). Similarly, the second kurtosis calculator 52 calculates the kurtosis K_{SSm} for each frame FR after suppression of the noise component n by the noise suppressor 26. For example, the second kurtosis calculator 52 is a second kurtosis calculation part which calculates the kurtosis K_{SSm} for each frame FR of the sound signal V_{OUT} by performing the calculation of Equation (9) on the M magnitudes x₁ to x_{M} extracted using the method of FIG. 2 from the time series of the frequency spectrum Yₘ(e^{jω}) after actual processing of the noise suppressor 26.

The calculator 54 of FIG. 7 is a calculation part which calculates a noise index value σₘ from the kurtosis K_{Xm} calculated by the first kurtosis calculator 51 and the kurtosis K_{SSm} calculated by the second kurtosis calculator 52. More specifically, the calculator 54 calculates the ratio K_{Rm} of the kurtosis K_{SSm} to the kurtosis K_{Xm} and calculates the noise index value σₘ by substituting the ratio K_{Rm} into the function F_{b} (i.e., σₘ=F_{b}(K_{Rm})=F_{b}(K_{SSm}/K_{Xm})).

The Function F_{b} defines a relation between the noise index value σₘ and the ratio K_{Rm} so that the noise index value σₘ monotonically increases with the ratio K_{Rm}. Accordingly, the noise index value σₘ serves as an index for quantitatively estimating the degree of occurrence of musical noise due to suppression of the noise component n. For example, the degree of musical noise after suppression of the noise component n can be estimated to increase as the noise index value σₘ calculated by the index calculator 32 increases (i.e., as the ratio K_{Rm} increases).

The suppression controller 36 variably sets the coefficient αₘ and the coefficient βₘ that the noise suppressor 26 uses for processing of the mth frame FR according to a noise index value σₘ−1 that the index calculator 32 has calculated for the immediately previous (i.e., the m−1th) frame FR. The suppression controller 36 uses the same methods (i.e., the methods of Equations (19) and (20)) as in the first embodiment to calculate the coefficient αₘ and the coefficient βₘ. Accordingly, this embodiment achieves the same advantages as those of the first embodiment.

In this embodiment, the coefficient αₘ and the coefficient βₘ are calculated from the noise index value σₘ−1 of the immediately previous frame FR. On the other hand, in the first embodiment, the coefficient αₘ and the coefficient βₘ that are applied to the mth frame FR are set according to the noise index value σₘ calculated from the sound signal V_{IN} of the mth frame FR. Accordingly, the first embodiment is preferable to the second embodiment in terms of quickly adapting the degree of suppression of the noise component n to changes of the characteristics of the sound signal V_{IN} (specifically, changes of an environment in which the sound signal V_{IN} is recorded).

However, the second embodiment may also employ a configuration in which the noise index value σₘ calculated from the mth frame FR is used to suppress the noise component n of the mth frame FR. For example, the noise suppressor 26 suppresses the noise component n for the mth frame FR in a state in which the coefficient αₘ and the coefficient βₘ are tentatively set to a predetermined value such as an initial value and the suppression controller 36 then applies the noise index value σₘ, which the index calculator 32 has calculated for the mth frame FR after suppression, to calculation of the coefficient αₘ and the coefficient βₘ that are applied to actual suppression of the noise component n of the mth frame FR.

As can be understood from the first and second embodiments, the invention includes both the configuration (of the first embodiment) in which the noise index value σₘ is calculated without actually calculating the kurtosis (K_{Xm} and K_{SSm}) before and after suppression of the noise component n and the configuration (of the second embodiment) in which the noise index value σₘ is calculated by actually calculating the kurtosis (K_{Xm} and K_{SSm}) before and after suppression of the noise component n.

### C: Modifications

Various modifications can be made to each of the above embodiments. The following are specific examples of such modifications. It is also possible to arbitrarily select and combine two or more from the following modifications.

(1) Modification 1

The relation between the kurtosis K_{Xm} or the kurtosis K_{SSm} and the noise index value σₘ (the kurtosis index value Rₘ in the first embodiment) is arbitrary in the invention. That is, the method for calculating the noise index value σₘ and the kurtosis index value Rₘ from kurtosis K_{Xm} or the kurtosis K_{SSm} is arbitrary in the invention. For example, taking into consideration the tendency that the degree of occurrence of musical noise in the sound signal V_{OUT} is reflected in the degree of change of the kurtosis (K_{Xm}→K_{SSm}) through the suppression of the noise component n, the invention may also employ a configuration in which the noise index value σₘ and the kurtosis index value Rₘ are calculated according to the difference |K_{SSm}−K_{Xm}| between the kurtosis K_{Xm} before suppression and the kurtosis K_{SSm} after suppression. In addition, the relation between the ratio K_{Rm} and the kurtosis index value Rₘ (i.e., the function Fₐ) and the relation between the ratio K_{Rm} and the noise index value σₘ (i.e., the function F_{b}) may be changed as appropriate. For example, the first embodiment employs a configuration in which the ratio K_{Rm} is used for the kurtosis index value Rₘ (i.e., Rₘ=K_{Rm}) or a configuration in which the kurtosis index value Rₘ is calculated by adding or subtracting a predetermined coefficient to or from the kurtosis index value Rₘ or by multiplying or dividing the kurtosis index value Rₘ by a predetermined coefficient. Similarly, the second embodiment employs a configuration in which the ratio K_{Rm} is output as the noise index value σₘ (i.e., K_{Rm}=σₘ) or a configuration in which the noise index value σₘ is calculated by adding or subtracting a predetermined coefficient to or from the ratio K_{Rm} or by multiplying or dividing the ratio K_{Rm} by a predetermined coefficient.

While each of the above embodiments focuses on the relation between the ratio K_{Rm} between the kurtosis K_{Xm} and the kurtosis K_{SSm} and the noise index value σₘ (or the kurtosis index value Rₘ in the first embodiment), the degree of occurrence of musical noise after suppression of the noise component n tends to exhibit a significant correlation especially with the logarithm of the ratio K_{Rm}. Accordingly, it is also preferable to employ a configuration in which the noise index value σₘ is calculated from the logarithm of the ratio K_{Rm} (i.e., a configuration in which the ratio K_{Rm} is replaced with the logarithm of the ratio K_{Rm} in each of the above embodiments). The configuration in which the logarithm of the ratio K_{Rm} is used is advantageous in that the degree of occurrence of musical noise can be estimated more accurately from the noise index value σₘ.

(2) Modification 2

Although both the kurtosis K_{Xm} of the sound signal V_{IN} and the kurtosis K_{SSm} after suppression of the noise component n are used to calculate the noise index value σₘ in each of the above embodiments, the invention also employs a configuration in which only one of the kurtosis K_{Xm} and the kurtosis K_{SSm} is used to calculate the noise index value σₘ. For example, when considering the tendency that musical noise more easily occurs in the sound signal V_{OUT} as the kurtosis K_{Xm} before suppression of the noise component n decreases, it is also preferable to employ a configuration in which the index calculator 32 calculates the noise index value σₘ so that the noise index value σₘ increases as the kurtosis K_{Xm} of the sound signal V_{IN} decreases (i.e., a configuration in which the noise index value σₘ does not depend on the kurtosis K_{SSm}).

In addition, when considering the tendency that musical noise more easily occurs in the sound signal V_{OUT} as the kurtosis K_{SSm} after suppression of the noise component n increases, it is also possible to employ a configuration in which the index calculator 32 calculates the noise index value σₘ so that the noise index value σₘ increases as the kurtosis K_{SSm} increases (i.e., a configuration in which the noise index value σₘ does not depend on the kurtosis K_{Xm}). However, when considering the tendency that the degree of change of the kurtosis (K_{Xm}→K_{SSm}) through the suppression of the noise component n is most significantly reflected in the degree of occurrence of musical noise in the sound signal V_{OUT}, it is preferable to employ a configuration in which the noise index value σₘ is calculated according to both the kurtosis K_{Xm} and the kurtosis K_{SSm} and it is especially preferable to employ a configuration in which the noise index value σₘ is calculated according to the degree of change of the kurtosis from the kurtosis K_{Xm} to the kurtosis K_{SSm} (i.e., the ratio or difference between the kurtosis K_{Xm} and the kurtosis K_{SSm}).

(3) Modification 3

Although each of the above embodiments has been illustrated with reference to the case where the noise index value σₘ monotonically increases with the ratio K_{Rm}, the relation between an increase or decrease of the ratio K_{Rm} (i.e., an increase or decrease of the kurtosis K_{Xm} or the kurtosis K_{SSm}) and an increase or decrease of the noise index value σₘ is changed appropriately according to a detailed method of controlling the noise suppressor 26 according to the noise index value σₘ. For example, the noise index value σₘ is calculated from the ratio K_{Rm} so that the noise index value σₘ decreases as the ratio K_{Rm} increases in a configuration in which the coefficient αₘ is defined such that the coefficient αₘ increases as the noise index value σₘ increases, contrary to Equation (19). That is, the invention preferably employs a configuration in which the degree of occurrence of musical noise represented by the noise index value σₘ increases as the ratio K_{Rm} increases (i.e., as the kurtosis K_{Xm} decreases or as the kurtosis K_{SSm} increases), regardless of whether the numerical value of the noise index value σₘ increases or decreases as the ratio K_{Rm} increases.

The scope of application of the invention is also not limited to the configuration in which the degree of suppression of the noise component n increases as the degree of occurrence of musical noise represented by the noise index value σₘ decreases. For example, it is also possible to employ a configuration in which the degree of suppression of the noise component n increases as the degree of occurrence of musical noise represented by the noise index value σₘ increases in the case where musical noise is positively generated in the sound signal V_{OUT}, for example for inspecting the characteristics of musical noise occurring in the sound signal V_{OUT} or for determining the quality of processing performed by the noise suppressor 26.

(4) Modification 4

Although the noise index value σₘ (specifically, the kurtosis K_{Xm}, the kurtosis K_{SSm}, the ratio K_{Rm}, or the kurtosis index value Rₘ) is calculated for each frame FR in each of the above embodiments, the period at intervals of which the index calculator 32 calculates the noise index value σₘ is arbitrary. For example, assuming that the noise index value σₘ undergoes little change in adjacent frames FR, the invention also employs a configuration in which the noise index value σₘ is calculated only for each of a plurality of frames FR that are sequentially selected at intervals of a predetermined number of frames FR or a configuration in which the average of the noise index value σₘ over a plurality of frames FR is indicated to the suppression controller 36 (or a configuration in which the noise index value σₘ is calculated from the average of the ratio K_{Rm} over a plurality of frames FR). It is also preferable to employ a configuration in which the index calculator 32 calculates a noise index value σₘ for each noise interval detected by the determinator 242 (i.e., for each interval in which the signal component s is small) and a noise index value σₘ of an immediately previous noise interval is used to calculate a coefficient αₘ of each frame FR in an interval including a signal component s (i.e., a configuration in which the noise index value σₘ is not updated in non-noise intervals).

(5) Modification 5

Detailed methods for calculating the kurtosis K_{Xm} and K_{SSm} before and after suppression of the noise component n are not limited to the above examples. For example, the configuration in which the frequence distribution of the magnitude of the sound signal V_{IN} is approximated using a predetermined function (for example, the function of Equation (6) or (11)) is not essential in the invention, and the invention also employs a configuration in which the kurtosis K_{Xm} is calculated directly from the sound signal V_{IN} (i.e., from the frequency spectrum Xₘ(e^{jω})) or a configuration in which the kurtosis K_{SSm} is calculated directly from the sound signal V_{OUT} (i.e., from the frequency spectrum Yₘ(e^{jω})).

(6) Modification 6

Although the desired value Rref, which is a target value of the degree of occurrence of musical noise, is fixed in the first embodiment, it is also preferable to employ a configuration in which the desired value Rref is variable. For example, the index determinator 44 variably sets the desired value Rref according to an instruction from the user (specifically, according to an operation that the user has performed on the input device). This configuration is advantageous in that the degree of occurrence of musical noise in the sound signal V_{OUT} (specifically, whether priority is given to suppression of the noise component n or to reduction of musical noise) can be adjusted, for example, according to user preferences.

(7) Modification 7

Although the sound signal V_{OUT} (i.e., the frequency spectrum Yₘ(e^{jω})) after actual processing of the noise suppressor 26 is used to calculate the kurtosis K_{SSm} in the second embodiment, the invention also employs a configuration in which the second kurtosis calculator 52 calculates the kurtosis K_{SSm} through the calculation of Equation (16). A coefficient αₘ calculated for a past frame FR (for example, a coefficient αₘ−1 calculated for an immediately previous frame FR) is used as the suppression coefficient A of Equation (16). This embodiment is advantageous in that it is possible to calculate the noise index value σₘ without waiting for the processing of the noise suppressor 26 since the sound signal V_{OUT} (i.e., the frequency spectrum Yₘ(e^{jω})) is not necessary for the calculation of the noise index value σₘ.

(8) Modification 8

The noise suppressor 26 may use any known technology to suppress the noise component n. For example, the invention employs a configuration in which the noise component n is suppressed by multiplying the magnitude of each frequency of the frequency spectrum Xₘ(e^{jω}) by a coefficient less than 1 according to the estimated noise spectrum ψₘ(e^{jω}). The suppression controller 36 variably controls the coefficient by which the frequency spectrum Xₘ(e^{jω}) is multiplied according to the noise index value σₘ.

(9) Modification 9

Although each of the above embodiments is illustrated with reference to the noise suppression device 100 including the noise suppressor 26 that suppresses the noise component n in the sound signal V_{IN}, the invention is also applicable to a device (i.e., a noise suppression estimation device) that is used to calculate a noise index value σₘ or a kurtosis index value Rₘ for estimating the degree of occurrence of musical noise (or for determining whether or not to suppress the noise component n). The noise suppression estimation device does not include the noise suppressor 26 and the suppression controller 36 in FIG. 1. In addition, although the noise index value σₘ is used to control the noise suppressor 26 in the above embodiments, the method of using the noise index value σₘ or the kurtosis index value Rₘ calculated by the noise suppression estimation device is arbitrary (i.e., the use of the noise index value σₘ or the kurtosis index value Rₘ is not limited to control of the noise suppressor 26). For example, the noise index value σₘ is used as a quantitative index for estimating the characteristics of the sound signal V_{IN} (specifically, estimating the ease of occurrence of musical noise). The noise index value σₘ calculated by the noise suppression estimation device is provided to each individual noise suppression device via a portable recording medium or a communication network and is then used to suppress the noise component n.

1. A noise suppression estimation device comprising:
an acquiring part that acquires a sound signal containing a signal component and a noise component; and
an index calculation part that calculates a noise index value which varies according to kurtosis of a frequence distribution of magnitude of the sound signal before or after suppression of the noise component, the noise index value indicating a degree of occurrence of musical noise after suppression of the noise component in a frequency domain.

2. The noise suppression estimation device according to claim 1, wherein the index calculation part comprises:
a correlation specification part that specifies a relation between a suppression coefficient representing a degree of suppression of the noise component and a kurtosis index value according to the kurtosis; and
an index determination part that determines the noise index value in terms of the suppression coefficient at which the kurtosis index value approaches or reaches a predetermined value in the relation specified by the correlation specification part.

3. The noise suppression estimation device according to claim 1, wherein the index calculation part comprises:
a first kurtosis calculation part that calculates first kurtosis of a frequence distribution of magnitude of the sound signal before suppression of the noise component;
a second kurtosis calculation part that calculates second kurtosis of a frequence distribution of magnitude of the sound signal after suppression of the noise component; and
a calculation part that calculates the noise index value from the first kurtosis and the second kurtosis.

4. The noise suppression estimation device according to claim 1, wherein the index calculation part calculates the noise index value according to first kurtosis of the sound signal before suppression of the noise component such that a degree of occurrence of musical noise represented by the noise index value increases as the first kurtosis decreases.

5. The noise suppression estimation device according to claim 1, wherein the index calculation part calculates the noise index value according to second kurtosis of the sound signal after suppression of the noise component such that a degree of occurrence of musical noise represented by the noise index value decreases as the second kurtosis decreases.

6. The noise suppression estimation device according to claim 1, wherein the index calculation part calculates the noise index value according to first kurtosis of the sound signal before suppression of the noise component and second kurtosis of the sound signal after suppression of the noise component such that a degree of occurrence of musical noise represented by the noise index value increases as a ratio of the second kurtosis to the first kurtosis increases.

7. The noise suppression estimation device according to claim 6, wherein the index calculation part calculates the noise index value according to a logarithm of the ratio of the second kurtosis to the first kurtosis such that a degree of occurrence of musical noise represented by the noise index value increases as the logarithm increases.

8. A machine readable recording medium containing a program causing a computer to perform:
an acquiring process of acquiring a sound signal containing a signal component and a noise component; and
an index calculation process of calculating a noise index value which varies according to kurtosis of a frequence distribution of magnitude of the sound signal before or after suppression of the noise component, the noise index value indicating a degree of occurrence of musical noise after suppression of the noise component in a frequency domain.

9. A noise suppression device comprising:
a noise suppression part that suppresses a noise component of a sound signal in a frequency domain;
an index calculation part that calculates a noise index value which varies according to kurtosis of a frequence distribution of magnitude of the sound signal before or after suppression of the noise component, the noise index value indicating a degree of occurrence of musical noise after suppression of the noise component; and
a suppression control part that variably controls a degree of suppression of the noise component by the noise suppression part according to the noise index value.

10. The noise suppression device according to claim 9, wherein the index calculation part comprises:
a correlation specification part that specifies a relation between a suppression coefficient representing a degree of suppression of the noise component and a kurtosis index value according to the kurtosis; and
an index determination part that determines the noise index value in terms of the suppression coefficient at which the kurtosis index value approaches or reaches a predetermined value in the relation specified by the correlation specification part.

11. The noise suppression device according to claim 9, wherein the index calculation part comprises:
a first kurtosis calculation part that calculates first kurtosis of a frequence distribution of magnitude of the sound signal before suppression of the noise component;
a second kurtosis calculation part that calculates second kurtosis of a frequence distribution of magnitude of the sound signal after suppression of the noise component; and
a calculation part that calculates the noise index value from the first kurtosis and the second kurtosis.

12. The noise suppression device according to claim 9, wherein the index calculation part calculates the noise index value according to first kurtosis of the sound signal before suppression of the noise component such that a degree of occurrence of musical noise represented by the noise index value increases as the first kurtosis decreases.

13. The noise suppression device according to claim 9, wherein the index calculation part calculates the noise index value according to second kurtosis of the sound signal after suppression of the noise component such that a degree of occurrence of musical noise represented by the noise index value decreases as the second kurtosis decreases.

14. The noise suppression device according to claim 9, wherein the index calculation part calculates the noise index value according to first kurtosis of the sound signal before suppression of the noise component and second kurtosis of the sound signal after suppression of the noise component such that a degree of occurrence of musical noise represented by the noise index value increases as a ratio of the second kurtosis to the first kurtosis increases.

15. The noise suppression device according to claim 14, wherein the index calculation part calculates the noise index value according to a logarithm of the ratio of the second kurtosis to the first kurtosis such that a degree of occurrence of musical noise represented by the noise index value increases as the logarithm increases.

16. The noise suppression device according to claim 9, wherein the suppression control part controls the degree of suppression of the noise component by the noise suppression part according to the noise index value such that the degree of suppression of the noise component increases as the degree of occurrence of musical noise represented by the noise index value decreases.

17. A machine readable recording medium containing a program causing a computer to perform:
a noise suppression process of suppressing a noise component of a sound signal in a frequency domain;
an index calculation process of calculating a noise index value which varies according to kurtosis of a frequence distribution of magnitude of the sound signal before or after suppression of the noise component of the sound signal, the noise index value indicating a degree of occurrence of musical noise after suppression of the noise component in a frequency domain; and
a suppression control process of variably controlling a degree of suppression of the noise component by the noise suppression process according to the noise index value.
